(19) United States
(12) Patent Application Publication
(10) Pub. No.: US 2020/0297567 A1
(43) Pub. Date: Sep. 24, 2020

(54) Myofascial Release Table

(71) Applicant: Charles Roger Lebano, III, Sonoma, CA (US)

(72) Inventor: Charles Roger Lebano, III, Sonoma, CA (US)

(21) Appl. No.: 16/356,678

(22) Filed: Mar. 18, 2019

(51) Int. Cl. A61G 13/00; A61H 15/00

(52) U.S. Cl. CPC A61G 13/009; A61H 15/00; A61H 2015/0014; A61H 2201/1635; A61H 2203/0456; A61H 2201/0138; A61H 2201/169; A61H 2205/081

(57) ABSTRACT

A myofascial release table includes a plurality of inline rollers used to perform myofascial release. The myofascial release table design allows for use by any size person, with any strength or flexibility level. The rollers in the table and the handles on the table side allow a user to position themselves easily on the rollers. The user has full control and does not have to have excellent flexibility or coordination to be successful. The physical difficulties of performing myofascial release are removed.

### BACKGROUND OF THE INVENTION

The present invention relates to myofascial release therapies, and more particularly to apparatus and methods for performing myofascial release therapies for alleviating muscle tension.

During myofascial release techniques, a user has to position their body against a roller which works the muscle. This roller (often formed of foam) is typically placed on a floor or other flat surface and the user's body must be placed on top of the roller. Typically, the user must assume awkward positions in order to apply pressure from the roller to the affected muscles to thereby release muscle tension. For some people, these positions are impossible to achieve due to the individual's limited flexibility, mobility, or sheer size of the person.

The problems with myofascial release foam rollers is that so many people are unable to use them due to their lack of physical flexibility limitations or are uncomfortable using them due to the coordination required for assuming the complex physical positions for these therapies.

As can be seen, there is a need for improved apparatus and method for myofascial release therapy that allows for use by any size person, with any strength or flexibility level. The rollers in the table and the handles on the table side allow a user to position themselves easily on the rollers. The user has full control and does not have to have excellent flexibility or coordination to be successful. The physical difficulties are removed.

### SUMMARY OF THE INVENTION

In one aspect of the present invention a myofascial release table is disclosed. The myofascial release table includes an arcuate base support, having a left and a right support member. The left and the right support member have arcuate legs defined at a first end and a second end thereof. A linear intermediate portion is defined between the arcuate legs.

A plurality of first rollers are rotationally disposed in a spaced apart relation between the left and the right support member. The plurality of first rollers beginning at an upper end of the arcuate legs and extending along the intermediate portion. At least one second roller rotationally disposed between the left and the right support member and interposed between the plurality of first rollers along the intermediate portion of the base support, the at least one second roller having a diameter substantially larger than that of the plurality of first rollers, the plurality of first rollers and the at least one second roller defining a rolling surface.

An upright handrail extends along a longitudinal length of at least one of the left and the right support member. The upright handrail is elevated with respect to the rolling surface. The handrail extends along the rolling surface and may include an upper hand rail and a lower hand rail that is substantially parallel the upper hand rail. In some embodiments, a plurality of hand grips extend between the upper hand rail and the lower hand rail. The plurality of hand grips may be oriented substantially orthogonal to the upper hand rail and the lower hand rail.

The rolling surface will preferably have a length to support a majority of a user's body while in a supine position on the rolling surface. The at least one second roller is positioned along a spinal area of the user's body when in a supine position on the rolling surface. The base support positions a horizontal component of the rolling surface at a seating height of the user.

In other aspects of the invention, a method of myofascial release therapy is disclosed. The method includes providing a myofascial release table having a plurality of in line first rollers that are rotationally disposed in a spaced apart relation between a left and a right base support. At least one second roller is rotationally disposed between the left and the right support member and is interposed between the plurality of first rollers along an intermediate portion of the base support. The at least one second roller has a diameter that is substantially larger than that of the plurality of first rollers. The plurality of first rollers and the at least one second roller define a rolling surface. The user is positioned in a supine position on the rolling surface so that the at least one second roller is positioned subjacent to the user's spine. The user is selectively repositioned along the rolling surface to work the at least one second roller against a targeted muscle group are of the user. The user may then be oriented along the rolling surface to position the second roller against a subsequent targeted muscle group.

A hand rail may be provided along a lateral side of the rolling surface. The user may utilize the handrail to position themselves on the myofascial release table. The user may also use the hand rail to perform the step of selectively repositioning.

These and other features, aspects and advantages of the present invention will become better understood with reference to the following drawings, description and claims.

### BRIEF DESCRIPTION OF THE DRAWINGS

FIG. 1 is an isometric view of a myofascial release table;

FIG. 2 is a plan view of the myofascial release table;

FIG. 3 is a front view of the myofascial release table;

FIG. 4 is a section view of the myofascial release table, taken along line 4-4 of FIG. 2;

FIG. 5 is a section view of the myofascial release table, taken along line 5-5 of FIG. 2;

FIG. 6 is a detailed section of 5-5 showing upper detail of large roller (14);

FIG. 7 is a detailed section of 5-5 showing upper rail (12) detail;

FIG. 8 is a section showing a user (38) sitting on the rollers (16); and

FIG. 9 is a section showing a user (38) lying on the rollers (16) using the hand rail (20) to move the body front to back.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an improved apparatus and method for a myofascial release therapy that allows for use by any size person, with any strength or flexibility level. The rollers in the table and the handles on the table side allow a user to position themselves easily on the rollers. The user has full control and does not have to have a high level of flexibility or coordination to be successful. The physical difficulties are removed.

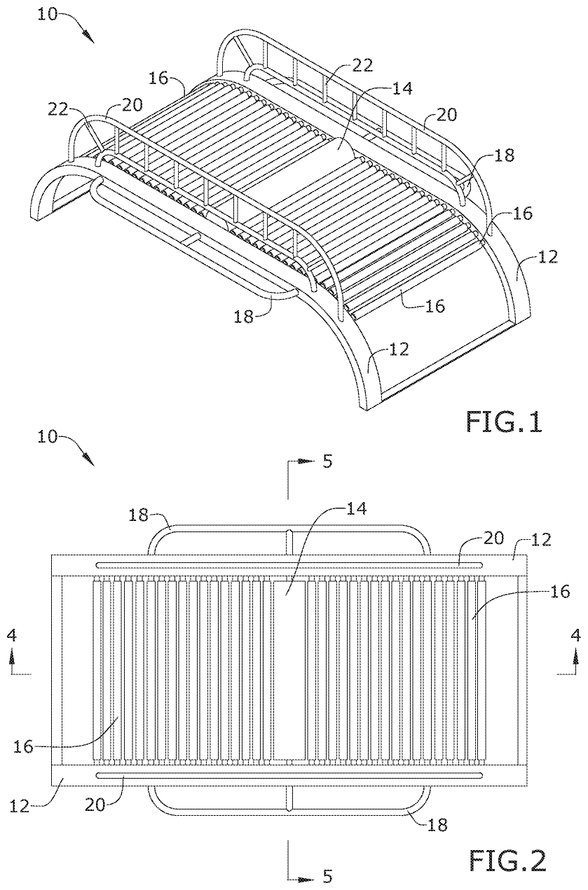

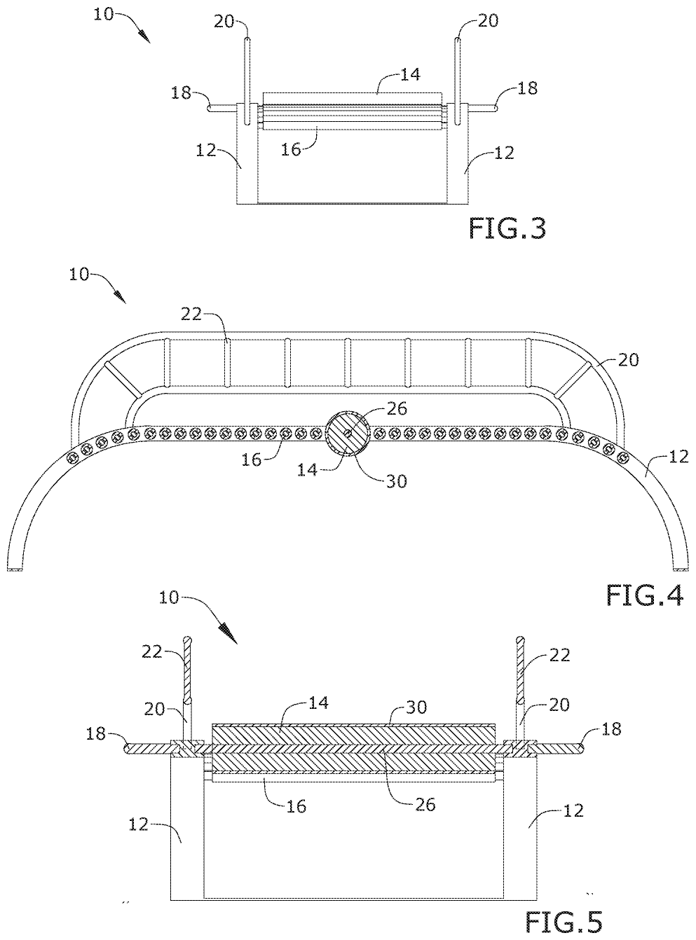

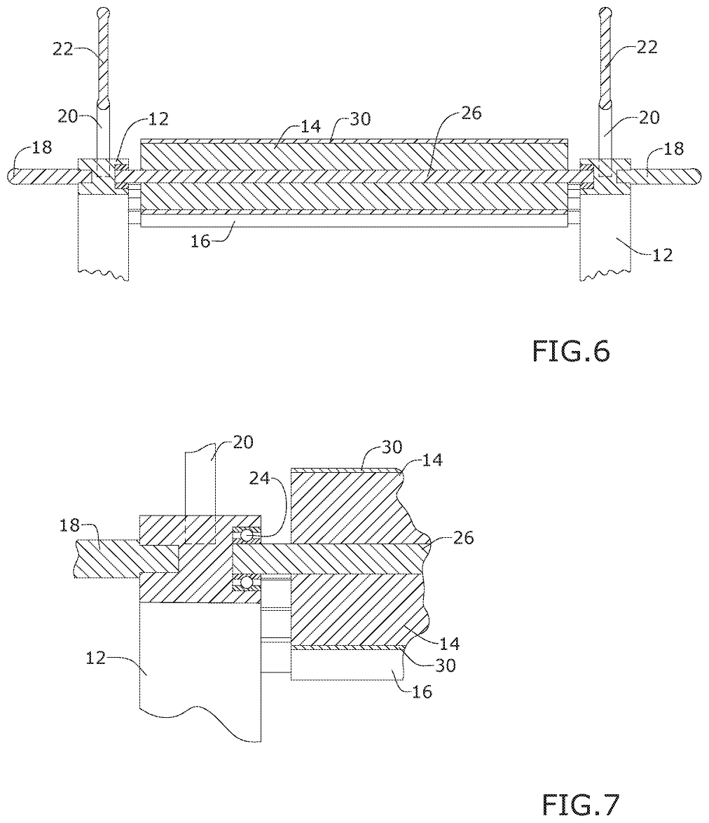

As seen in reference to the drawings of FIGS. 1-7, a myofascial release table 10 according to aspects of the present invention is shown. The myofascial release table includes an arcuate base support 12, having a left and a right support member. The base support 12 may include arcuate legs defined at a first end and a second end thereof. A linear intermediate portion is defined between the arcuate legs of the base support 12.

A plurality of first rollers 16 are rotationally disposed in a spaced apart relation between the left and the right support member. The plurality of first rollers may begin at an upper end of the arcuate legs and extend along the intermediate portion.

At least one second roller 14 is rotationally disposed between the left and the right support member and is interposed between the plurality of first rollers 16 along the intermediate portion of the base support. The at least one second roller 14, or myofascial roller, will have a diameter that is substantially larger than that of the plurality of first rollers 16. Preferably an axis of the second roller 14 is linearly aligned with that of the plurality of first rollers 16. The plurality of first rollers 16 and the at least one second roller define a rolling surface.

An upright handrail 20 extends along a longitudinal length of the base support 12 and is elevated with respect to the rolling surface. The upright handrail 20 extends along a length of the rolling surface. The upright handrail 20 may include n upper hand rail and a lower hand rail that substantially parallel to the upper hand rail. A plurality of hand grips 22 may extend between the upper hand rail and the lower hand rail. The plurality of hand grips 22 may be oriented substantially orthogonal to the upper hand rail and the lower hand rail.

A lateral hand rail 18 may extend laterally from the myofascial release table 10 so that it is aligned with the plurality of first rollers. As with the upright handrail 20, the lateral hand rail 18 may include one or more hand grips.

The rolling surface has a length to support a majority of a user's body in a supine position on the rolling surface. The at least one second roller 14 is positioned so that it will be in contact along a spinal area of a user's body when they are in a supine position on the rolling surface. The base support 12 and arcuate legs are dimensioned so as to position a horizontal component of the rolling surface at a seating height of the user.

The plurality of first rollers 16 are carried on a shaft and preferably have bearings to facilitate rotation of the rollers. The at least one second roller 14 is carried on a roller shaft 26 and is supported for rotation via a bearing 24. The at least one second roller 14, may be formed with an interior padding with an exterior cover 30 surrounding the padding.

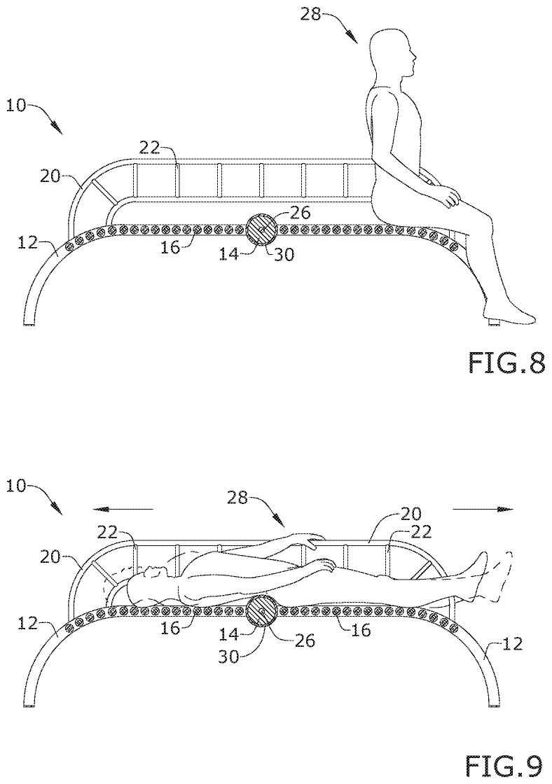

A method of using the myofascial release table for myofascial release therapy may be seen in reference to FIGS. 8 and 9. The user 28 may sit upon the rolling surface at a first end of the support table 10. The upright handrail 20 may be utilized for maintaining stability on the table 10. The support table 10 may be vertically adjustable such that the user's feet may contact the ground when sitting upon the rolling surface.

The user 28 may then lay back to assume a supine position on the rolling surface so that the at least one second roller 14 is positioned subjacent to the user's spine. The user 28 may then selectively repositioning themselves longitudinally along the rolling surface to work the at least one second roller 14 against a targeted muscle group of the user 28. If the user 28 wants to target a subsequent targeted muscle group, the user would reposition on the rolling surface with one of the upright hand rail 20 or the lateral hand rail 18. As will be appreciated from the present disclosure, the myofascial release table 10 provides the user 28 the ability to engage in myofascial release therapy without the need to assume any unusual positions requiring flexibility or significant coordination. The myofascial release table 10 may also be utilized by a therapist to assist a user 28 with like results.

It should be understood, of course, that the foregoing relates to exemplary embodiments of the invention and that modifications may be made without departing from the spirit and scope of the invention as set forth in the following claims.

What is claimed is:

1. A myofascial release table, comprising:
an arcuate base support, having a left and a right support member, the left and the right support member having arcuate legs defined at a first end and a second end thereof, and a linear intermediate portion defined between the arcuate legs;
a plurality of first rollers rotationally disposed in a spaced apart relation between the left and the right support member, the plurality of first rollers beginning at an upper end of the arcuate legs and extending along the intermediate portion; and
at least one second roller rotationally disposed between the left and the right support member and interposed between the plurality of first rollers along the intermediate portion of the base support, the at least one second roller having a diameter substantially larger than that of the plurality of first rollers, the plurality of first rollers and the at least one second roller defining a rolling surface.

2. The myofascial release table of claim 1, further comprising:
a handrail extending along a longitudinal length of at least one of the left and the right support member, the handrail elevated with respect to the rolling surface.

3. The myofascial release table of claim 2, wherein the handrail extends along the rolling surface.

4. The myofascial release table of claim 2, the handrail further comprising:
an upper hand rail; and
a lower hand rail substantially parallel to the upper hand rail.

5. The myofascial release table of claim 4, further comprising:
a plurality of hand grips extending between the upper hand rail and the lower hand rail.

6. The myofascial release table of claim 5, wherein the plurality of hand grips are oriented substantially orthogonal to the upper hand rail and the lower hand rail.

7. The myofascial release table of claim 1, wherein the rolling surface has a length to support a majority of a user's body in a supine position on the rolling surface.

8. The myofascial release table of claim 7, wherein the at least one second roller is positioned along a spinal area of a user's body when in a supine position on the rolling surface.

9. The myofascial release table of claim 1, wherein the base support positions a horizontal component of the rolling surface at a seating height of the user.

10. A method of myofascial release therapy, comprising:
providing a myofascial release table comprising:
a plurality of in line first rollers rotationally disposed in a spaced apart relation between a left and a right base support; and
at least one second roller rotationally disposed between the left and the right support member and interposed between the plurality of first rollers along an intermediate portion of the base support, the at least one second roller having a diameter substantially larger than that of the plurality of first rollers, the plurality of first rollers and the at least one second roller defining a rolling surface; and
positioning the user in a supine position on the rolling surface so that the at least one second roller is subjacent to the user's spine.

11. The method of claim 10, further comprising:
selectively repositioning the user along the rolling surface to work the at least one second roller against a targeted muscle group are of the user.

12. The method of claim 11, further comprising:
orienting the user along the rolling surface to position the second roller against a subsequent targeted muscle group.

13. The method of claim 11, further comprising:
providing a hand rail along a lateral side of the rolling surface; and
using the hand rail by the user to position them self on the myofascial release table.

14. The method of claim 13, further comprising:
using the hand rail by the user perform the step of selectively repositioning.
